(19) United States
(12) Patent Application Publication
(10) Pub. No.: US 2018/0176489 A1
(43) Pub. Date: Jun. 21, 2018

(54) IMAGE-CAPTURE DEVICE, IMAGE ACQUISITION DEVICE, IMAGE ACQUISITION METHOD, IMAGE PROCESSING DEVICE, AND IMAGE PROCESSING PROGRAM

(71) Applicant: HAMAMATSU PHOTONICS K.K., Hamamatsu-shi, Shizuoka (JP)

(72) Inventors: Tokuhiro KOIKE, Hamamatsu-shi, Shizuoka (JP); Takayuki INOUE, Hamamatsu-shi, Shizuoka (JP); Teruo TAKAHASHI, Hamamatsu-shi, Shizuoka (JP)

(73) Assignee: HAMAMATSU PHOTONICS K.K., Hamamatsu-shi, Shizuoka (JP)

(21) Appl. No.: 15/735,346

(22) PCT Filed: Mar. 30, 2016
(86) PCT No.: PCT/JP2016/060378

§ 371 Date: Dec. 11, 2017

(30) Foreign Application Priority Data
Jun. 18, 2015 (JP) 2015-122668

(51) Int. Cl. H04N 5/357; H04N 5/16; H04N 5/232

(52) U.S. Cl. CPC H04N 5/357; H04N 5/23229; H04N 5/16

(57) ABSTRACT

A camera unit includes an image sensor having a light-receiving surface in which pixels are two-dimensionally arranged, the pixels having a photodiode for converting input light into an electrical signal and outputting an analog signal and an AD conversion unit for converting the analog signal into a digital signal based on a dark offset value indicating a black level of an image, and an image processing circuit having a clip value set in accordance with the dark offset value and configured to perform a conversion process of converting a digital value of a digital signal having a digital value that is smaller than the clip value into the clip value and output image data based on a digital signal after the conversion process.

### TECHNICAL FIELD

An aspect of the present invention relates to an image-capture device, an image acquisition device, an image acquisition method, an image processing device, and an image processing program.

### BACKGROUND ART

An image-capture device equipped with an electronic multiplying charge coupled devices (EMCCD) sensor is known as an image-capture device for capturing an image of weak light emitted from an object such as a cell (for example, see Patent Literature 1). In the image-capture device, electrical charge subjected to photoelectrical conversion is multiplied by a multiplication unit and is subjected to AD conversion, so that image data with a high S/N ratio can be acquired.

### CITATION LIST

### Patent Literature

[Patent Literature 1] Japanese Unexamined Patent Publication No. 2008-271049

### SUMMARY OF INVENTION

### Technical Problem

Also, an image-capture device equipped with a complementary metal oxide semiconductor (CMOS) sensor is known as an image-capture device for capturing an image of weak light as described above. Compared with the image-capture device equipped with an EMCCD sensor, the image-capture device has a merit in that a frame rate is high and a field of view is wide. On the other hand, because AD conversion is performed for each pixel of the CMOS sensor, variation in a digital value after AD conversion tends to occur between pixels. In a state in which a predetermined pixel value is set as a dark offset value which is a black level, when an image of weak light is captured, the digital values of the digital signal vary and are distributed in the vicinity of the dark offset value. When the digital values vary in the vicinity of the dark offset value which is the black level, a digital value smaller than the dark offset value may increase and the pixel value of the dark offset value which is the black level may become relatively large. In this case, there is a problem in that the contrast of the image is lowered.

An aspect of the present invention has been made in view of the above circumstances, and an objective of the present invention is to provide an image with high contrast even when an image of weak light is captured using an image sensor which performs AD conversion for each pixel.

### Solution to Problem

According to an aspect of the present invention, there is provided an image-capture device including: an image sensor having a light-receiving surface in which pixels are two-dimensionally arranged, the pixels having a photodiode for converting input light into an electrical signal and outputting an analog signal and an AD conversion unit for converting the analog signal into a digital signal based on a dark offset value indicating a black level of an image; and a data processing unit having a clip value set in accordance with the dark offset value and configured to perform a conversion process of converting a digital value of a digital signal having a digital value that is smaller than the clip value into the clip value and output image data based on a digital signal after the conversion process.

In this image-capture device, the clip value is set according to the dark offset value indicating the black level of the image. That is, the clip value is set according to the dark offset value which is a threshold value of the digital value for which black is displayed in the image. The digital value of a digital signal whose digital value is smaller than the clip value among the digital signals subjected to the AD conversion in the AD conversion unit of the image sensor is converted into the clip value. Thereby, all the digital values smaller than the dark offset value are clip values. When an image of weak light is captured, if the digital value of the digital signal varies around the dark offset value, a digital value smaller than the dark offset value may increase and the pixel value of the dark offset value that is the black level may be relatively large. In this case, there is a problem that the image may be entirely white and the contrast of the image is lowered. In this regard, all the digital values smaller than the clip value set in accordance with the dark offset value are set to the clip value, so that it is possible to decrease a digital value smaller than the dark offset value and suppress a relative increase in the pixel value of the dark offset value. Thereby, it is possible to provide an image with high contrast even when an image of weak light is captured.

Also, the clip value may be a dark offset value. Thereby, all the digital values smaller than the dark offset value are set to the dark offset value, so that there are no digital values smaller than the dark offset value. Thereby, it is possible to prevent the pixel value of the dark offset value from being relatively large and provide an image with higher contrast.

Also, the data processing unit may correct the digital value of a digital signal having a digital value larger than or equal to a predetermined threshold value among digital signals. Thereby, it is possible to eliminate white spot noise when an image is displayed.

Also, the data processing unit may perform digital gain processing on the digital signal. Thereby, because the conversion process of converting the digital signal amplified by the digital gain processing into the clip value is performed, the conversion process can be performed more accurately and easily.

Also, the data processing unit may perform an averaging process on the digital signal. Thereby, it is possible to eliminate white spot noise when an image is displayed.

Also, the data processing unit may perform an addition process on the digital signal. Thereby, it is possible to eliminate white spot noise when an image is displayed.

According to an aspect of the present invention, there is provided an image acquisition device including: the above-described image-capture device; a table creation unit configured to create a lookup table in which each digital value in the image data is associated with a predetermined pixel value based on a distribution of digital values of digital signals in the image data output from the data processing unit of the image-capture device; and a data conversion unit configured to convert each digital value in the image data into the predetermined pixel value and generate display image data based on the lookup table.

In this image acquisition device, display image data is generated from the lookup table created based on a distribution of digital values in image data in which all digital values smaller than the dark offset value are set to the clip value. A range of the pixel value in the display image data generated by the image acquisition device is predetermined. If the lookup table is created based on image data in which the digital value of the digital signal varies in the vicinity of the dark offset value, the contrast in the display image data generated based on the lookup table decreases. In this regard, it is possible to provide a display image with high contrast even if an image of weak light is captured by creating the look-up table based on image data in which a minimum value of a pixel value is set as the clip value.

According to an aspect of the present invention, there is provided an image acquisition method of generating display image data based on light from an object using an image sensor having a light-receiving surface in which pixels including a photodiode and an AD conversion unit are two-dimensionally arranged. The image acquisition method includes the steps of: outputting an analog signal by photoelectrically converting input light using the photodiode; converting the analog signal into a digital signal based on a dark offset value indicating a black level of an image using the AD conversion unit; performing a conversion process of converting a digital value of a digital signal having a digital value that is smaller than the clip value set in accordance with the dark offset value among digital signals into the clip value and outputting image data based on a digital signal after the conversion process; creating a lookup table in which each digital value in the image data is associated with a predetermined pixel value based on a distribution of digital values of digital signals in the pixel data; and converting each digital value in the image data into the predetermined pixel value and generating display image data based on the lookup table.

Also, according to an aspect of the present invention, there is provided an image processing device for processing a digital signal output from an image sensor having a light-receiving surface in which pixels are two-dimensionally arranged, the pixels having a photodiode for converting input light into an electrical signal and outputting an analog signal and an AD conversion unit for converting the analog signal into the digital signal based on a dark offset value indicating a black level of an image, the image processing device including: a data processing unit having a clip value set in accordance with the dark offset value and configured to perform a conversion process of converting a digital value of a digital signal having a digital value that is smaller than the clip value into the clip value and output image data based on a digital signal after the conversion process.

Also, the image processing device further includes: a table creation unit configured to create a lookup table in which each digital value in the image data is associated with a predetermined pixel value based on a distribution of digital values of digital signals in the image data output from the data processing unit; and a data conversion unit configured to convert each digital value in the image data into the predetermined pixel value and generate display image data based on the lookup table.

Also, according to an aspect of the present invention, there is provided an image processing program for causing an image processing circuit to operate as, in an image processing device for processing a digital signal output from an image sensor having a light-receiving surface in which pixels are two-dimensionally arranged, the pixels having a photodiode for converting input light into an electrical signal and outputting an analog signal and an AD conversion unit for converting the analog signal into the digital signal based on a dark offset value indicating a black level of an image, a data processing unit having a clip value set in accordance with the dark offset value and configured to perform a conversion process to convert a digital value of a digital signal having a digital value that is smaller than the clip value into the clip value and output image data based on a digital signal after the conversion process.

Also, the image processing program further causes the image processing circuit to operate as: a table creation unit configured to create a lookup table in which each digital value in the image data is associated with a predetermined pixel value based on a distribution of digital values of digital signals in the image data output from the data processing unit; and a data conversion unit configured to convert each digital value in the image data into the predetermined pixel value and generate display image data based on the lookup table.

Also, in the image obtaining method, the image processing device, and the image processing program, the clip value may be a dark offset value. Thereby, because all the digital values smaller than the dark offset value are set to the dark offset value, there are no digital values smaller than the dark offset value. Thereby, it is possible to prevent the pixel value of the dark offset value from being relatively large and provide an image with higher contrast.

### Advantageous Effects of Invention

According to an aspect of the present invention, it is possible to provide an image having high contrast even when an image of weak light is captured in an image-capture device provided with an image sensor which performs AD conversion for each pixel.

### BRIEF DESCRIPTION OF DRAWINGS

FIG. 1 is a configuration diagram of an image acquisition device according to a first embodiment of the present invention.

FIG. 2 is a diagram illustrating an AD conversion process in an image acquisition device of FIG. 1.

FIG. 3 is a diagram illustrating a white spot elimination process in the image acquisition device of FIG. 1.

FIG. 4 is a diagram illustrating digital gain processing in the image acquisition device of FIG. 1.

FIG. 5 is a diagram illustrating a clipping process in the image acquisition device of FIG. 1.

FIG. 6 is a diagram illustrating a digital value distribution of image data in an image-capture device equipped with a CMOS sensor according to a comparative example.

FIG. 7 is a diagram illustrating display image data generated using the image-capture device of FIG. 6.

FIG. 8 is a diagram illustrating a digital value distribution of image data in the image acquisition device of FIG. 1.

FIG. 9 is a diagram illustrating display image data generated using the image-capture device of FIG. 1.

FIG. 10 is a configuration diagram of an image acquisition device according to a second embodiment of the present invention.

### DESCRIPTION OF EMBODIMENTS

Hereinafter, embodiments of the present invention will be described in detail with reference to the drawings. In the drawings, the same or corresponding parts are denoted by the same reference signs, and redundant description thereof will be omitted.

### First Embodiment

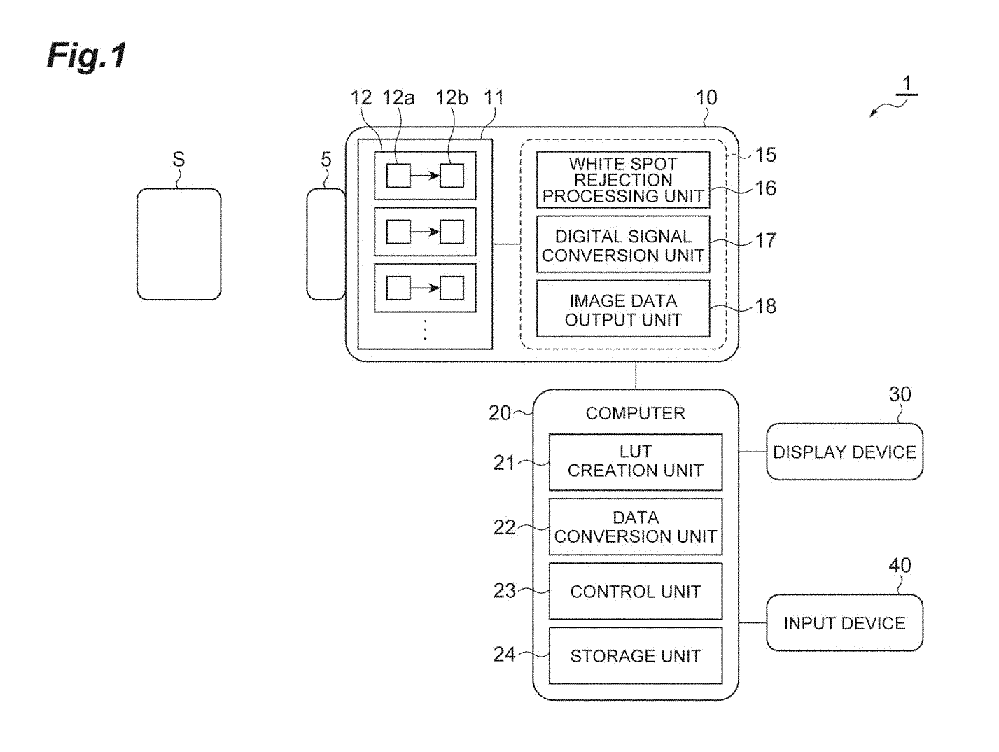

As illustrated in FIG. 1, an image acquisition device 1 is a device that radiates excitation light to a sample S (object), receives fluorescence generated as a result of the radiation, and acquires image data. The sample S is, for example, tissue cells held on a holding member such as a glass slide or a Petri dish, and is placed on a predetermined stage (not illustrated) which is a holding unit for holding the holding member. The tissue cells of the sample S are dyed, for example, with a fluorescent substance. Also, the image acquisition device 1 does not necessarily have to receive the fluorescence of the sample S and may receive light from the sample S such as other emitted light such as self-luminescence, reflected light, transmitted light, or scattered light and acquire image data. Also, the sample S is not limited to tissue cells, and may be a living body such as an animal or an industrial product such as a solar cell or a semiconductor device. Hereinafter, it is assumed that the image acquisition device 1 acquires image data based on fluorescence of the sample S, but the description and illustration of a configuration (for example, a light source) for irradiating the sample S with the excitation light are omitted. The image acquisition device 1 may be various image acquisition devices such as microscope devices of various configurations such as a bright field microscope device, a dark field microscope device, and a reflection type microscope device, a flow cytometer, and the like.

The image acquisition device 1 includes a lens unit 5, a camera unit 10 (an image-capture device), a computer 20, a display device 30, and an input device 40.

The lens unit 5 has a lens that forms an image of fluorescence emitted from the sample S on the light-receiving surface of the image sensor 11 (to be described below) of the camera unit 10. The lens unit 5 is attached to a lens mount portion of the camera unit 10.

The camera unit 10 is an image-capture device including the image sensor (an image sensor) 11 for receiving light from the sample S via the lens unit 5 and an image processing circuit 15 (a data processing unit) for performing a predetermined process on electrical signals from the image sensor 11.

The image sensor 11 is a CMOS image sensor having a light-receiving surface in which a plurality of pixels 12 are two-dimensionally arranged. In the image sensor 11, the input light is converted into an electrical signal in each pixel 12, and the electrical signal is output. Each pixel 12 is configured to include a photodiode 12a and an AD conversion unit 12b. The photodiode 12a converts input light input via the lens unit 5 into an electrical signal, more specifically, a voltage signal, and outputs an analog signal after photoelectrical conversion. The AD conversion unit 12b converts the analog signal output from the photodiode 12a into a digital signal and outputs the digital signal. In the AD conversion unit 12b, a predetermined dark offset value is predetermined as a pixel value indicating a black level of an image. The black level is a predetermined threshold value for setting a pixel value smaller than or equal to the black level to black. Specifically, the dark offset value is set to, for example, a count of 100. The dark offset value indicates the black level, but is set to a value larger than a count of 0 in consideration of noise included in the analog signal. This is because it is not possible to express a value smaller than the dark offset value when the value smaller than the dark offset value is observed due to noise included in the analog signal if the dark offset value has a count of 0. That is, the dark offset value is set to fall within an input range of the AD conversion unit 12b even if darkness fluctuates due to noise.

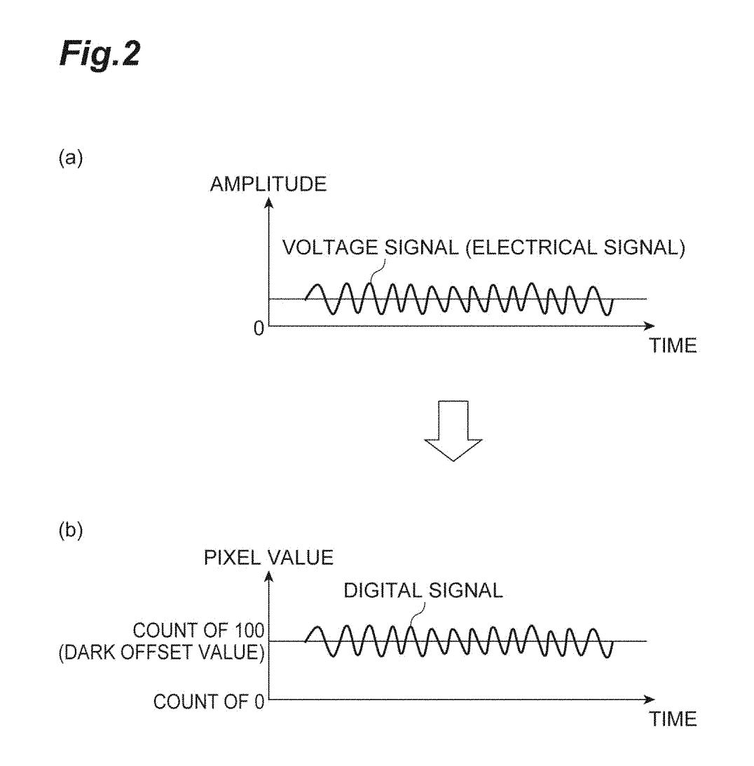

AD conversion by the AD conversion unit 12b will be described with reference to FIG. 2. FIG. 2(a) illustrates a voltage signal input to the AD conversion unit 12b. In FIG. 2(a), the horizontal axis represents time and the vertical axis represents amplitude of a voltage signal. FIG. 2(b) illustrates a digital signal after the AD conversion. In FIG. 2(b), the horizontal axis represents time and the vertical axis represents a pixel value (luminance value). As illustrated in FIGS. 2(a) and 2(b), the AD conversion is performed so that a pixel value according to an amplitude value of a voltage signal is reached. Here, if a voltage signal input to the AD conversion unit 12b is a voltage signal based on weak input light, a digital value of the digital signal is a value in the vicinity of the dark offset value and becomes a value smaller than the dark offset value as illustrated in FIG. 2(b). As described above, the dark offset value is set to a value larger than a count of 0, specifically, a count of 100.

The image processing circuit 15 is a data processing unit (an image processing device) that outputs image data based on the digital signal output from the AD conversion unit 12b of the image sensor 11. The image processing circuit 15 includes a field-programmable gate array (FPGA), an image processing processor, or the like. According to a program (an image processing program) stored in a memory of the image processing circuit 15, the FPGA or the image processing processor of the image processing circuit 15 operates as a white spot elimination processing unit 16, a digital signal conversion unit 17, and an image data output unit 18. Accordingly, the image processing circuit 15 is a data processing unit (an image processing device) including the white spot elimination processing unit 16, the digital signal conversion unit 17, and the image data output unit 18.

The white spot elimination processing unit 16 performs a first white spot elimination process and a second white spot elimination process on the digital signal output from the AD conversion unit 12b. The first white spot elimination process and the second white spot elimination process of the white spot elimination processing unit 16 are performed in a stage previous to the conversion process (to be described below) by the digital signal conversion unit 17. Also, the first white spot elimination process and the second white spot elimination process may be performed in a stage subsequent to the conversion process or at the same time thereas. The white spot elimination process is a process of suppressing the occurrence of white spot noise when a digital signal having an extremely large digital value is displayed as an image in comparison with other digital signals.

The first white spot elimination process is a process of correcting the digital value of a digital signal of which the digital value is larger than or equal to a predetermined threshold value among the digital signals of pixels 12. Specifically, the white spot elimination processing unit 16 identifies a pixel 12 related to a digital signal whose digital value (pixel value) is larger than or equal to a predetermined threshold value. Further, the white spot elimination processing unit 16 replaces the digital value of the digital signal of the identified pixel 12 (which hereinafter may be simply referred to as the pixel value of the pixel 12) with an average value of pixel values of the pixels 12 around the identified pixel 12. The surrounding pixels are, for example, eight pixels 12 other than the identified pixel 12 in a set of 3×3 pixels 12 around the identified pixel 12. In addition to the first white spot elimination process, the white spot elimination processing unit 16 may perform a process of correcting the digital value of a digital signal whose digital value is smaller than a predetermined threshold value (a threshold value different from the above-described threshold value).

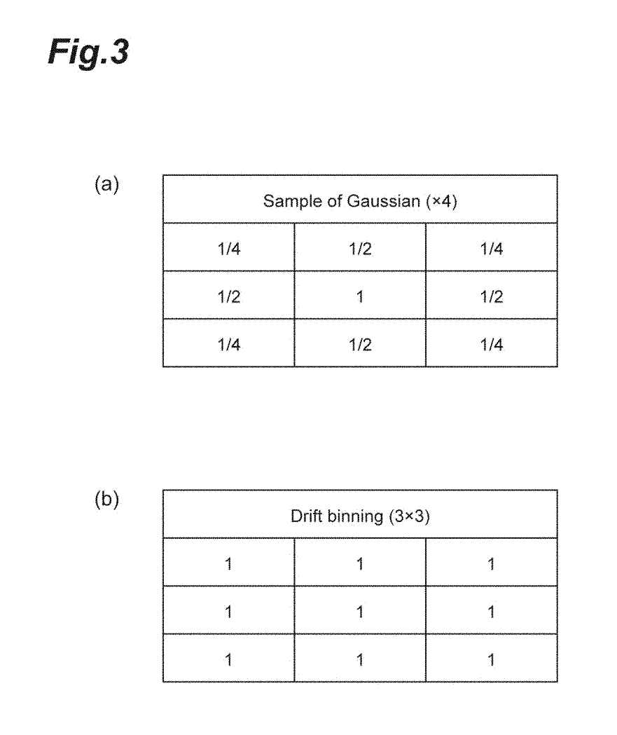

For example, the second white spot elimination process is a process of averaging the pixel values of all the pixels 12 using the pixel values of the pixels 12 around each pixel 12. Specifically, the white spot elimination processing unit 16 performs a filtering process using a Gaussian filter, drift binning, or the like on the digital signal and performs an averaging process. In the filtering process using a Gaussian filter, the white spot elimination processing unit 16 first identifies a set of 3×3 pixels 12 around one pixel 12. Further, the white spot elimination processing unit 16 assigns a weighting coefficient to each pixel 12 of the set of the identified pixels 12. FIG. 3(a) illustrates a weighting coefficient of each pixel 12 in the set of 3×3 pixels 12. In the example illustrated in FIG. 3(a), a weighting coefficient of one center pixel 12 is set to “1,” weighting coefficients of pixels 12 on the left of, the right of, above and below the center pixel 12 are set to “½,” and weighting coefficients of pixels 12 in a left diagonally upward direction, a left diagonally downward direction, a right diagonally upward direction, and a right diagonally downward direction of the center pixel 12 are set to “¼.” The white spot elimination processing unit 16 calculates a weighted pixel value of each pixel 12 by multiplying the pixel value of each pixel 12 in the above-described set of pixels 12 by the weighting coefficient of each pixel. A value obtained by dividing a sum of the weighted pixel values of the pixels 12 by a sum of the weighting coefficients of the pixels 12 (1+1/2×4+1/4×4=4 in the example illustrated in FIG. 3(a)) is set to a pixel value of one center pixel 12 after the averaging process. The white spot elimination processing unit 16 derives a pixel value after the averaging process for all the pixels 12. A filtering process using drift binning is generally similar to a filtering process using a Gaussian filter. However, while different weighting coefficients are assigned to pixels 12 of the set of pixels 12 in the Gaussian filter, the same weighting coefficient “1” is assigned to the pixels of the set of pixels 12 as illustrated in FIG. 3(b) in drift binning. In the averaging process using a Gaussian filter or drift binning, the set of pixels 12 is not limited to the set of 3×3 pixels 12.

Although the averaging process has been described as the second white spot elimination process, an addition process may be performed instead of the averaging process. In the addition process, the white spot elimination processing unit 16 identifies, for example, a set of 3×3 pixels 12 around one pixel 12, and sets a sum of the weighted pixel values of the pixels 12 in the set of pixels 12 as a pixel value of one center pixel 12 by using a Gaussian filter, drift binning, or the like.

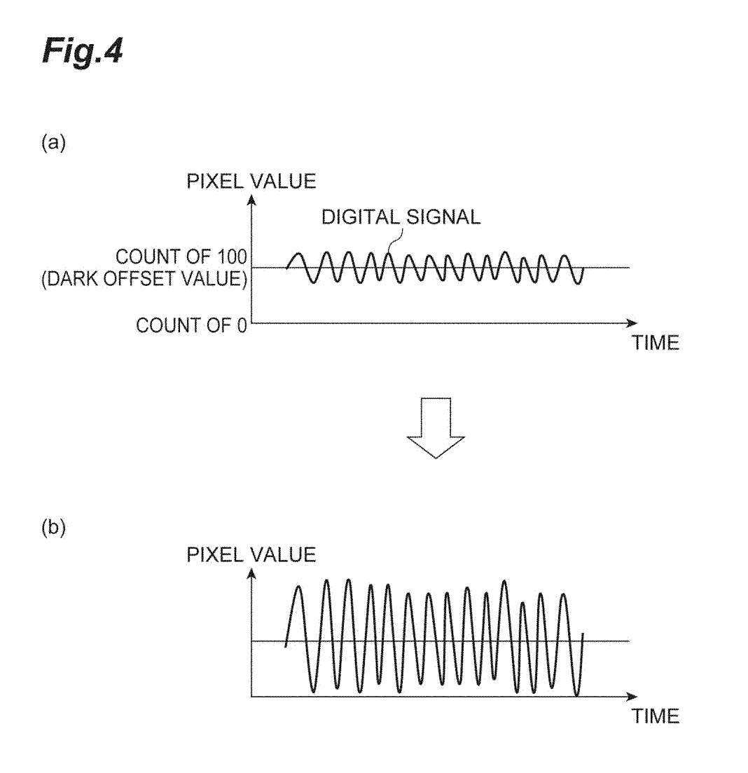

The digital signal conversion unit 17 performs digital gain processing on the digital signal on which the white spot elimination process has been performed by the white spot elimination processing unit 16. FIG. 4(a) illustrates a digital signal before digital gain processing. FIG. 4(b) illustrates a digital signal after digital gain processing. Even after the digital gain processing, the digital value of the digital signal is distributed in the vicinity of the dark offset value with the dark offset value as the center. Also, the digital gain processing by the digital signal conversion unit 17 may be omitted. Also, the digital gain processing may be performed in a stage subsequent to the first white spot elimination process, the second white spot elimination process, and the conversion process or at the same time.

The digital signal conversion unit 17 has a clip value set in accordance with the dark offset value and performs a conversion process of converting a digital value of a digital signal having a digital value smaller than the clip value into the clip value. The clip value is a threshold value in a certain process and is a value used for converting all values smaller (or larger) than the clip value into clip values. Here, the clip value is a threshold value in the above-described conversion process and is a value used for converting all digital values smaller than the clip value into the clip value. The clip value is set in accordance with the dark offset value. The fact that the clip value is set in accordance with the dark offset value means that the clip value is set based on the dark offset value when there is a digital value to be converted into a clip value by the conversion process. The clip value is, for example, a dark offset value. In this case, all the digital values smaller than the dark offset value are set to the dark offset value by the conversion process.

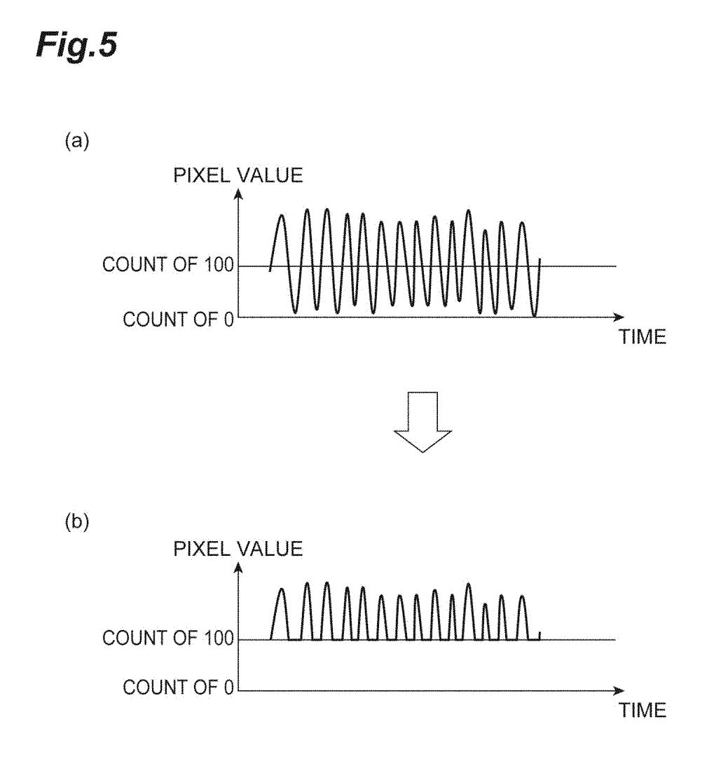

FIG. 5(a) illustrates a digital signal before the conversion process. FIG. 5(b) illustrates a digital signal after the conversion process. In the example illustrated in FIG. 5, a clip value is a dark offset value. As illustrated in FIG. 5(a), a digital signal before the conversion process has a digital value smaller than a count of 100 which is the dark offset value. On the other hand, because the clip value is set as the dark offset value as illustrated in FIG. 5(b) after the conversion process, all the digital values in a range smaller than the dark offset value are set to the count of 100 which is the dark offset value.

The image data output unit 18 outputs image data based on a digital signal after the conversion process by the digital signal conversion unit 17 to the computer 20.

The computer 20 generates display image data to be displayed on the display device 30 based on the image data output from the camera unit 10. For example, the computer 20 is implemented by a personal computer or a tablet terminal together with a display device 30 and an input device 40 to be described below. The computer 20 has an image processing circuit such as an FPGA or an image processing processor. The image processing circuit of the computer 20 operates as an LUT creation unit 21, a data conversion unit 22, a control unit 23, and a storage unit 24 according to a program stored in the memory of the computer 20. Accordingly, the computer 20 includes the LUT creation unit 21, the data conversion unit 22, the control unit 23, and the storage unit 24.

Based on a distribution of digital values of digital signals in image data output from the camera unit 10, the LUT creation unit 21 is a table creation unit which creates a lookup table (LUT) in which each digital value in the image data is associated with a predetermined pixel value. A range of the predetermined pixel values, that is, a minimum value and a maximum value of the predetermined pixel values, are predetermined. The LUT creation unit 21 associates the minimum value of the digital values in the image data with the minimum value of the predetermined pixel values and creates an LUT in which the maximum value of the digital values in the image data is associated with the maximum value of the predetermined pixel values. In the LUT, a correspondence relation between the minimum value and the maximum value is determined, and the correspondence relation in another range is also determined. For example, when the correspondence relation between the minimum value and the maximum value is determined in the LUT, the correspondence relation in another range is also determined to be a proportional relation uniquely determined from the correspondence relation between the minimum value and the maximum value. A relation determined from the correspondence relation is not limited to a proportional relation, and may be another relation such as a squared function relation. The LUT creation unit 21 creates an LUT every time image data is output from the camera unit 10. The LUT creation unit 21 may create the LUT only at the time of initial setting, rather than every time the image data is output from the camera unit 10.

Based on the LUT created by the LUT creation unit 21, the data conversion unit 22 converts each digital value in the image data into a predetermined pixel value and generates display image data. As described above, in the LUT, the digital value of the image data output from the camera unit 10 is associated with a predetermined pixel value. Thus, the data conversion unit 22 can output predetermined pixel values associated with digital values of the image data based on the LUT by using each digital value of the image data output from the camera unit 10 as an input. The data conversion unit 22 generates display image data based on each pixel value after conversion. The data conversion unit 22 outputs the display image data to the display device 30.

The control unit 23 controls the camera unit 10, the display device 30, and the input device 40. For example, the control unit 23 controls image-capture conditions of the camera unit 10. The image-capture conditions are, for example, an image-capture mode, an exposure time, and the like. The storage unit 24 stores the LUT created by the LUT creation unit 21 and the image data output from the camera unit 10. Also, the storage unit 24 may be an auxiliary storage device such as HDD or SSD of the computer 20 or an external storage device electrically coupled to the computer 20. The LUT creation unit 21 and the data conversion unit 22 perform the above-described process based on the data stored in the storage unit 24.

The display device 30 is a display such as a liquid crystal display or an organic EL display. The display device 30 displays an image of the sample S by displaying the display image data. The input device 40 is a keyboard, a mouse, and the like. The input device 40 receives settings regarding image-capture conditions of the camera unit 10, that is, an image-capture mode, an exposure time, and the like from the user.

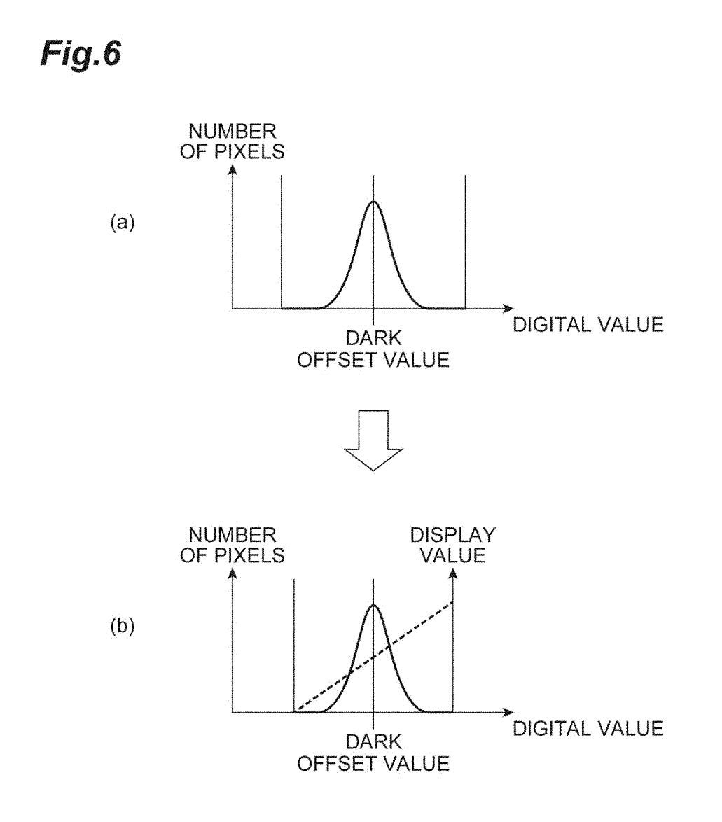

Next, operations and effects of the camera unit 10 and the image acquisition device 1 will be described with reference to FIGS. 6 to 9.

Conventionally, an image sensor that performs AD conversion for each pixel, for example, an image-capture device equipped with a CMOS sensor, is known. Compared to an image-capture device equipped with an EMCCD sensor, the image-capture device has a merit in that the price is low, the frame rate is high, and the field of view is wide. On the other hand, because AD conversion is performed for each pixel of the CMOS sensor, a digital value after the AD conversion tends to vary between pixels. Thus, when an image of weak light is captured in a state in which a predetermined pixel value is set as a dark offset value which is a black level, digital values vary and are distributed in the vicinity of the dark offset value. FIG. 6(a) illustrates a digital value distribution of image data in such an image-capture device. In FIG. 6(a), the horizontal axis represents a digital value and the vertical axis represents the number of pixels. As illustrated in FIG. 6(a), when an image of weak light is captured, the number of pixels whose digital values are the dark offset value is largest, but digital values vary in the vicinity of the dark offset value and are distributed. When digital values vary in the vicinity of the dark offset value which is the black level, there are many digital values smaller than the dark offset value. Thereby, the pixel value of the dark offset value which should originally have been the smallest pixel value is relatively large.

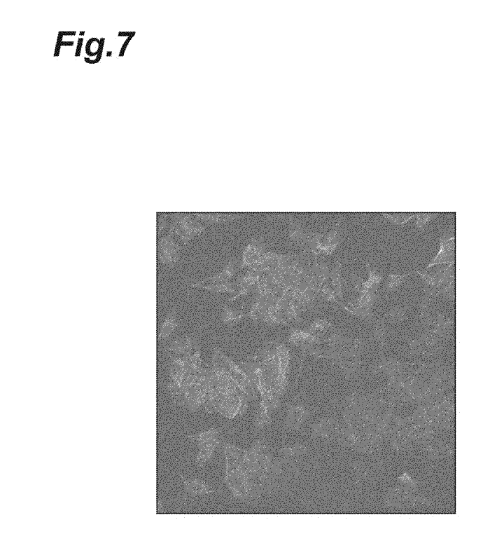

FIG. 6(b) is a diagram obtained by adding the correspondence relation of the LUT to FIG. 6(a). In FIG. 6(b), the vertical axis indicates the display value in addition to the number of pixels. The display value indicates a pixel value obtained by converting the digital value of the image data based on the LUT. That is, in FIG. 6(b), a relation between a digital value of the image data and a display value of the display image data is indicated by a broken line. As illustrated in FIG. 6(b), the LUT associates the minimum value of the digital value in the image data with the minimum value of the predetermined display value, and associates the maximum value of the digital value in the image data with the maximum value of the predetermined display value. Thus, when the LUT is created in a state in which the pixel value of the dark offset value is relatively large and display image data is generated based on the LUT, the dark offset value which should have been originally the smallest pixel value is converted into a relatively large display value in the display image data. Thereby, a portion of the display image data originally desired to have been displayed in black is white, and the contrast in the display image is lowered. FIG. 7 illustrates a display image with such reduced contrast. In the display image illustrated in FIG. 7, the contrast is lowered and the sample in the image cannot be clearly checked.

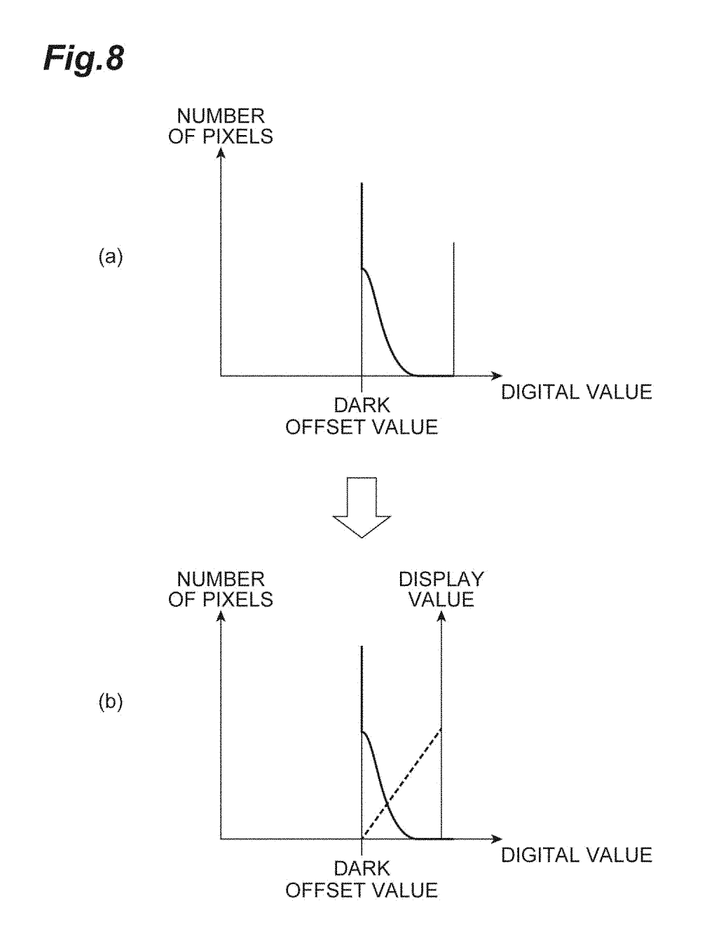

On the other hand, in the camera unit 10 of the present embodiment, the clip value is set in accordance with the dark offset value set as the black level. More specifically, the clip value is the dark offset value. A digital value of a digital signal whose digital value is smaller than the clip value among digital signals subjected to the AD conversion in the AD conversion unit 12b of the image sensor 11 is converted into the clip value. FIG. 8(a) illustrates a digital value distribution of image data in the camera unit 10 after conversion into the clip value. As illustrated in FIG. 8(a), because all the digital values smaller than the dark offset value which is the clip value are converted into the dark offset value which is the clip value, the number of pixels of the dark offset value is increased when compared with FIG. 6(a).

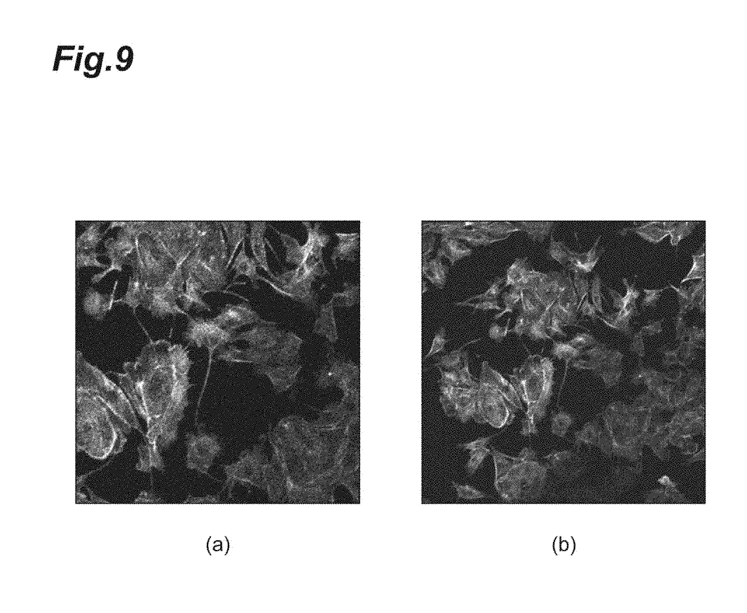

FIG. 8(b) is a diagram obtained by adding a correspondence relation of the LUT to FIG. 8(a). In FIG. 8(b), the relation between the digital value of the image data and the display value of the display image data is indicated by a broken line. As illustrated in FIG. 8(b), the LUT associates the minimum value of the digital value in the image data with the minimum value of the predetermined display value, and associates the maximum value of the digital value in the image data with the maximum value of the predetermined display value. Because all the digital values smaller than the dark offset value are converted into the dark offset value that is the clip value unlike in the example illustrated in FIG. 6(b), the minimum value of the digital value in the image data is set as the dark offset value in the LUT illustrated in FIG. 8(b). Because the dark offset value is converted into the minimum value of the display value if the display image data is generated based on such an LUT, it is possible to display a portion originally to have been displayed in black in black and increase contrast in the display image. FIG. 9(b) illustrates a display image generated when an image of weak light is captured using the camera unit 10. Also, FIG. 9(a) illustrates a display image generated when an image of weak light is captured using an image-capture device equipped with an EMCCD sensor. As illustrated in FIGS. 9(a) and 9(b), by using the camera unit 10, the contrast in the display image is increased and the contrast of the camera unit 10 equipped with the CMOS sensor can be set to be about the same as that of the image-capture device equipped with the EMCCD sensor.

Also, as described above, the clip value is set as the dark offset value, so that all the digital values smaller than the dark offset value are set to the dark offset value and there are no digital values smaller than the dark offset value. Thereby, it is possible to effectively prevent the pixel value of the dark offset value from being relatively large and provide a display image with higher contrast

Also, in a stage previous to the conversion process to the above-described clip value, the white spot elimination processing unit 16 performs a first white spot elimination process, which is a process of correcting the digital value of a digital signal whose digital value is larger than or equal to a predetermined threshold value. Further, the white spot elimination processing unit 16 performs a second white spot elimination process, which is a process of averaging or summing the pixel values of all the pixels 12 using the pixel values of the pixels 12 surrounding each pixel 12. Thereby, it is possible to eliminate white spot noise when an image is displayed as a display image.

Also, in the stage previous to the conversion process to the above-described clip value, the digital signal conversion unit 17 performs digital gain processing on the digital signal. Thereby, because the LUT is created for the digital signal amplified by the digital gain processing, it is possible to create the LUT more accurately and easily. Specifically, for example, when the user manually changes the minimum value and the maximum value of the LUT or the like, it is possible to smoothly perform the manual work because the digital signal is amplified.

### Second Embodiment

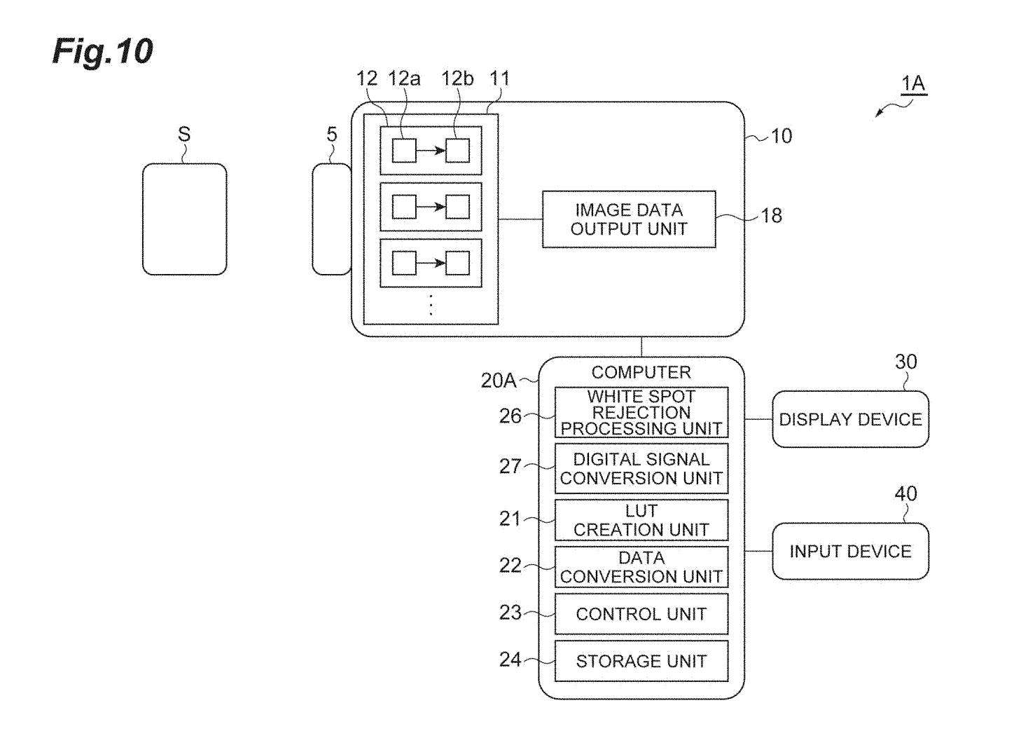

Next, an image acquisition device according to the second embodiment will be described with reference to FIG. 10. In the description of the second embodiment, differences from the above-described first embodiment will mainly be described.

An image acquisition device 1A according to the second embodiment performs the white spot elimination process, the digital gain processing, and the conversion process in a computer 20A. As illustrated in FIG. 10, the image acquisition device 1A is different from the image acquisition device 1 according to the first embodiment in that the computer 20A includes a white spot elimination processing unit 26 and a digital signal conversion unit 27. The image data output unit 18 of the camera unit 10 outputs a digital signal output from the AD conversion unit 12b of the image sensor 11 as image data to the computer 20A.

The computer 20A is an image processing device that generates display image data to be displayed on the display device 30 based on the image data output from the camera unit 10. The computer 20A includes an image processing circuit such as an FPGA or an image processing processor. The image processing circuit of the computer 20A operates as the white spot elimination processing unit 26, the digital signal conversion unit 27, the LUT creation unit 21, the data conversion unit 22, the control unit 23, and the storage unit 24 according to a program (an image processing program) stored in the memory of the computer 20A. Accordingly, the computer 20 includes the white spot elimination processing unit 26, the digital signal conversion unit 27, the LUT creation unit 21, the data conversion unit 22, the control unit 23, and the storage unit 24.

The white spot elimination processing unit 26 is a data processing unit that performs a first white spot elimination process and a second white spot elimination process on the digital signal output from the camera unit 10. The first white spot elimination process and the second white spot elimination process of the white spot elimination processing unit 26 are similar to the first white spot elimination process and the second white spot elimination process of the white spot elimination processing unit 16 of the first embodiment.

The digital signal conversion unit 27 is a data processing unit that performs digital gain processing on a digital signal subjected to the white spot elimination process by the white spot elimination processing unit 26. Also, the digital signal conversion unit 27 has a clip value set in accordance with the dark offset value and is a data processing unit that performs a conversion process of converting a digital value of a digital signal having a digital value smaller than the clip value into the clip value.

Based on a distribution of digital values of digital signals in the image data output from the digital signal conversion unit 27, the LUT creation unit 21 is a table creation unit which creates a lookup table (LUT) in which each digital value in the image data and a predetermined pixel value are associated.

In the computer 20A of the image acquisition device 1A according to the second embodiment, the white spot elimination processing unit 26 performs the first white spot elimination process and the second white spot elimination process based on the digital signal output from the camera unit 10. Then, digital gain processing is performed on the digital signal subjected to the white spot elimination process by the white spot elimination processing unit 26, and a conversion process is performed on digital data subjected to the digital gain processing. Therefore, similar to the LUT creation unit 21 of the image acquisition device 1 according to the first embodiment, the LUT creation unit 21 can create a lookup table (LUT) in which each digital value in the image data and a predetermined pixel value are associated based on a distribution of digital values of digital signals after the conversion process output from the digital signal conversion unit 27. Also, the white spot elimination processing or the digital gain processing is not limited to a stage previous to the conversion process, and may be performed in the subsequent stage or at the same time, or may be omitted.

Although the embodiments of the present invention have been described above, the present invention is not limited to the above-described embodiments. For example, although the clip value has been described as the dark offset value, the present invention is not limited thereto. It is only necessary for the clip value to be a digital value set in accordance with the dark offset value as long as a digital value is set so that a digital value may be converted into a clip value by the conversion process. If relevant conditions are satisfied, the clip value may be a digital value smaller or larger than the dark offset value. If an image of weak light is captured, a weak signal having valid information as well as dark noise may be included in values smaller than the dark offset value. If the clip value is set as the dark offset value, there is a possibility that valid information of such a weak signal may be lost. By making the clip value smaller than the dark offset value in this respect, it is possible to reduce the information of the signal lost by the conversion processing to the clip value. Also, by making the clip value larger than the dark offset value, the dark offset value is displayed in black, and an image with higher contrast can be displayed.

Although an example in which the white spot elimination process and the digital gain processing are performed in a stage before the conversion process for the clip value has been described, the conversion process for the clip value may be performed after the AD conversion without performing the white spot elimination process and the digital gain processing.

Also, in the first embodiment, the image processing circuit of the image processing circuit 15 of the camera unit 10 may operate as an LUT creation unit and a data conversion unit according to a program. In this case, the image processing circuit 15 serves as a data processing unit having the white spot elimination processing unit 16, the digital signal conversion unit 17, the image data output unit 18, the LUT creation unit, and the data conversion unit. Also, in the second embodiment, the image processing circuit of the camera unit 10 may function as a white spot elimination processing unit that performs the first white spot elimination process. In this case, the first white spot elimination process can be executed by the image processing circuit of the camera unit 10, and the second white spot elimination process can be executed by the image processing circuit of the computer 20A.

Also, although an example of an image-capture device equipped with a CMOS sensor has been described as the image-capture device according to an aspect of the present invention, the image-capture device is not limited thereto. The image-capture device may be other image-capture devices having an image sensor that performs AD conversion for each pixel.

### REFERENCE SIGNS LIST

1 Image acquisition device
10 Camera unit (image-capture device)
11 Image sensor
12 Pixel
12a Photodiode
12b AD conversion unit
15 Image processing circuit (data processing unit, image processing device)
16, 26 White spot elimination processing unit (data processing unit)
17, 27 Digital signal conversion unit (data processing unit)
20A Computer (image processing device)
21 LUT creation unit (table creation unit)
22 Data conversion unit
S Sample (object)

1. An image-capture device comprising:
an image sensor having a light-receiving surface pixels are two-dimensionally arranged in, the pixels having a photodiode configured to convert input light into an electrical signal and output an analog signal and an AD converter configured to convert the analog signal into a digital signal based on a dark offset value indicating a black level of an image; and
a data processor having a clip value set in accordance with the dark offset value and configured to perform a conversion process for converting a digital value of a digital signal having a digital value that is smaller than the clip value into the clip value and outputting image data based on a digital signal after the conversion process.

2. The image-capture device according to claim 1, wherein the clip value is the dark offset value.

3. The image-capture device according to claim 1, wherein the data processor is configured to correct a digital value of a digital signal having a digital value larger than or equal to a predetermined threshold value among digital signals.

4. The image-capture device according to claim 1, wherein the data processor is configured to perform digital gain processing on the digital signal.

5. The image-capture device according to claim 1, wherein the data processor is configured to perform an averaging process on the digital signal.

6. The image-capture device according to claim 1, wherein the data processor is configured to perform an addition process on the digital signal.

7. An image acquisition device comprising:
the image-capture device according to claim 1;
a table creator configured to create a lookup table in which each digital value in the image data is associated with a predetermined pixel value based on a distribution of digital values of digital signals in the image data output from the image-capture device; and
a data converter configured to convert each digital value in the image data into the predetermined pixel value and generate display image data based on the lookup table.

8. An image acquisition method for generating display image data based on light from an object using an image sensor having a light-receiving surface pixels comprising a photodiode and an AD converter are two-dimensionally arranged in, the image acquisition method comprising:
outputting an analog signal by photoelectrically converting input light using the photodiode;
converting the analog signal into a digital signal based on a dark offset value indicating a black level of an image by the AD converter;
performing a conversion process for converting a digital value of a digital signal having a digital value that is smaller than a clip value set in accordance with the dark offset value among digital signals into the clip value and outputting image data based on a digital signal after the conversion process;
creating a lookup table in which each digital value in the image data is associated with a predetermined pixel value based on a distribution of digital values of digital signals in the pixel data; and
converting each digital value in the image data into the predetermined pixel value and generating display image data based on the lookup table.

9. The image acquisition method according to claim 8, wherein the clip value is the dark offset value.

10. An image processing device for processing a digital signal output from an image sensor having a light-receiving surface pixels are two-dimensionally arranged in, the pixels having a photodiode for converting input light into an electrical signal and outputting an analog signal and an AD converter for converting the analog signal into the digital signal based on a dark offset value indicating a black level of an image, the image processing device comprising:
a data processor having a clip value set in accordance with the dark offset value and configured to perform a conversion process of converting a digital value of a digital signal having a digital value that is smaller than a clip value into the clip value and outputting image data based on a digital signal after the conversion process.

11. The image processing device according to claim 10, wherein the clip value is the dark offset value.

12. The image processing device according to claim 10, further comprising:
a table creator configured to create a lookup table in which each digital value in the image data is associated with a predetermined pixel value based on a distribution of digital values of digital signals in the image data output from the data processor; and
a data converter configured to convert each digital value in the image data into the predetermined pixel value and generate display image data based on the lookup table.

13. An image processing program for causing an image processing circuit to generate display image data based on light from an object using an image sensor having a light-receiving surface pixels comprising a photodiode for converting input light into an electrical signal and outputting an analog signal and an AD converter are two-dimensionally arranged in and for converting the analog signal into the digital signal based on a dark offset value indicating a black level of an image, the program causing the image processing circuit to execute:
performing a conversion process for converting a digital value of a digital signal having a digital value that is smaller than a clip value set in accordance with the dark offset value among digital signals into the clip value; and
outputting image data based on a digital signal after the conversion process.

14. The image processing program according to claim 13, wherein the clip value is the dark offset value.

15. The image processing program according to claim 13, wherein the image processing program further causes the image processing circuit to execute:
creating a lookup table in which each digital value in the image data is associated with a predetermined pixel value based on a distribution of digital values of digital signals in the pixel data; and
converting each digital value in the image data into the predetermined pixel value and generating display image data based on the lookup table.
